(19) United States
(12) Patent Application Publication
(10) Pub. No.: US 2026/0056312 A1
(43) Pub. Date: Feb. 26, 2026

(54) Vehicle-Mounted Integrated Radar-Camera Sensor

(71) Applicant: Aptiv Technologies AG, Schaffhausen (CH)

(72) Inventors: Gabor Vinci, Fürth (DE); Martin Bornemann, Nürnberg (DE)

(21) Appl. No.: 19/308,464

(22) Filed: Aug. 25, 2025

Related U.S. Application Data
(60) Provisional application No. 63/686,391, filed on Aug. 23, 2024.
(60) Provisional application No. 63/742,384, filed on Jan. 6, 2025.

(51) Int. Cl. G01S 13/86; G01S 13/931

(52) U.S. Cl. CPC G01S 13/867; G01S 13/931; G01S 2013/93272; G01S 2013/93274

(57) ABSTRACT

A vehicle control system includes a sensor device. The sensor device includes an optical sensor with a first field of view, a radar with a second field of view, and a common housing enclosing the optical sensor and the radar. The vehicle control system includes a control module configured to receive sensor data, including both optical data and radar data, from the sensor device over a shared communications channel. The control module is configured to determine whether an object is present within a threshold distance of the vehicle. The control module is configured to determine whether the object is moving. The control module is configured to determine whether the object satisfies one or more of a set of alert criteria. The control module is configured to generate an alert and a set of characteristic data describing the object.

### CROSS-REFERENCE TO RELATED APPLICATIONS

This application claims the benefit of U.S. Provisional Application No. 63/742,384 filed Jan. 6, 2025 and U.S. Provisional Application No. 63/686,391 filed Aug. 23, 2024. The entire disclosures of the above applications are incorporated by reference.

### FIELD

The present disclosure relates to autonomous vehicles and more particularly to camera and radar sensor packages.

### BACKGROUND

It is common for modern vehicles to incorporate sensor systems to assist users in parking and controlling the vehicle, either by providing the driver with feedback or providing positional data for autonomous driving systems. As an example, some systems use an array of ultrasonic distance sensors located in the vehicle's bumper, with the transmitted ultrasonic sound from each sensor being reflected back to provide a linear distance measurement of objects in front of each respective sensor. As another example, some parking systems rely on ultrasonic sensing with some advanced systems implementing birds eye view (BEV) camera perception on top. Other sensor systems rely on radar systems located in the front grill, below the bumper, and/or installed at a B-pillar. However, these perception systems have limitations in terms of reliability and accuracy, making current slow-speed maneuvering and parking aid systems and advanced driver assistance systems (ADAS) unreliable. Systems that use traditional radar installation locations (such as vehicle bumpers, the vehicle front grill, and/or vehicle B-pillars) cannot provide a seamless coverage in the immediate vicinity of the vehicle, even if the sensing devices are capable of short range sensing.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A vehicle control system includes a sensor device. The sensor device includes an optical sensor with a first field of view, a radar with a second field of view, and a common housing enclosing the optical sensor and the radar. The radar includes a transceiver and an antenna element. The sensor device is configured to be installed at an exterior surface of a vehicle. The vehicle control system includes a control module configured to receive sensor data, including both optical data and radar data, from the sensor device over a shared communications channel. The control module configured is to determine, based on a single frame of the optical data and a corresponding portion of the radar data, whether an object is present within a threshold distance of the vehicle. The control module configured is to, in response to a determination of presence of the object, determine, based on the single frame and the corresponding portion of the radar data, whether the object is moving. The control module configured is to, in response to a determination of presence of the object and in response to a determination that the object is moving, determine, using the sensor data, whether the object satisfies one or more of a set of alert criteria. The control module configured is to, in response to a determination of presence of the object and in response to a determination that the object satisfies one or more of the set of alert criteria, generate an alert and a set of characteristic data describing the object.

In other features, the control module is configured to, using the radar data, map pixels of the optical data to distances. In other features, the control module is configured to, determine, based on the sensor data, whether a low-height object is present within a threshold distance of the vehicle. The low-height object is characterized by having a height less than a height threshold. In other features, the control module is configured to, in response to a determination of presence of the low-height object, determine whether the low-height object satisfies one or more of a set of low-height alert criteria, and in response to a determination that the low-height object satisfies one or more of the set of low-height alert criteria, generate the alert and a set of characteristic data describing the low-height object.

In other features, the first field of view and the second field of view overlap. In other features, the first field of view and the second field of view are coextensive. In other features, the second field of view is aligned with an optical axis of the optical sensor. In other features, a radar lobe of the antenna element is centered with respect to a line that is in parallel to the optical axis. In other features, the transceiver is directly connected to the antenna element. In other features, the radar includes a plurality of antenna elements, of which the antenna element is one. In other features, the control module is configured to generate an output to a driver of the vehicle in response to the alert.

In other features, the output includes at least one of a visual alert on a user interface associated with a driver of the vehicle, an auditory alert, or a haptic alert. In other features, the control module is configured to control the vehicle in response to the alert. In other features, the control module is configured to selectively reduce speed of the vehicle in response to the alert. In other features, the control module is configured to selectively reduce the speed of the vehicle to zero in response to the alert. In other features, the control module is configured to selectively modify a steering angle of the vehicle in response to the alert.

In other features, the control module is configured to determine, from the set of characteristic data, whether the object is located in a direction of travel of the vehicle. In other features, the control module is configured to control the vehicle in response to a determination that the object is located in the direction of travel.

In other features, the control module is configured to predict, from the set of characteristic data, whether, at a future point in time, a first envelope defining the exterior surface of the vehicle overlaps with a second envelope defining an exterior of the object. In other features, the control module is configured to control the vehicle in response to a prediction that the first envelope and the second envelope will overlap.

In other features, the first envelope is a polyhedron and the second envelope is a polyhedron. In other features, the threshold distance is in a range of 1 meter to 3 meters. In other features, the control module is configured to project the sensor data on a representation of a three-dimensional map in a user interface. In other features, the set of alert criteria includes a criterion that is met when the object is within a second threshold distance of the vehicle. In other features, the second threshold distance is less than the threshold distance.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is an example application of a rear-mounted radar-camera sensor.

FIG. 2 is an example application of a side-mounted radar-camera sensor.

FIGS. 3-4 are examples of a side-mounted radar-camera sensor detecting a low-height object.

FIG. 5 is an example application of a front-mounted radar-camera sensor.

FIG. 6 is a block diagram of an example radar-camera sensor system.

FIGS. 7-8 are an example of a vehicle with mounted radar-camera sensors.

In the drawings, reference numbers may be reused to identify similar and/or identical elements.

### DETAILED DESCRIPTION

### Introduction

The present disclosure describes a method and system for sensing obstacles around a vehicle via a bird's eye view (BEV) device. A BEV device is a combination radar-camera sensor. Combining sensors allows for a cost effective ultrashort range sensing solution for existing parking applications and enables a variety of enhanced sensing features. Traditional BEV cameras perform a geometric estimate of the surrounding area based on images and cannot measure distance. Therefore, BEV systems that include only BEV cameras cannot give a reliable representation of the immediate surroundings of a vehicle. However, with integrated radar sensing, 3D information can be extracted from the scene, including accurate distance measurement to objects around the vehicle.

In some implementations, one or more BEV devices are mounted on a vehicle at an elevated location (for example, near or in rear view mirrors, near or above the vehicle bumpers, and/or below one or more vehicle windows). In some implementations, the one or more BEV devices are oriented downward to detect objects below the mounting location. In some implementations, one or more BEV devices are mounted in various locations on the vehicle. For example, to a vehicle tailgate, grill, and beneath the side-view mirrors.

In some implementations, the one or more BEV devices are connected to a controller module that is configured to generate a video output and is configured to receive the video outputs and process these in combination with the radar outputs to generate an augmented video output with visual and/or audible indicators representing the distances between detected objects and the periphery of the vehicle.

### Radar-Camera Sensor

In various embodiments, the radar-camera sensor includes an optical sensor and a detection device (such as a radar device) for providing images or sequences of images. In various embodiments, the optical sensor device includes at least one lens. In various embodiments, the optical sensor is configured as a camera system in which one or more objective lenses generate an image of the external environment of the radar-camera sensor system. In various embodiments, the optical sensor is configured to detect light in the visible range and/or in the infrared range of the electromagnetic spectrum in order to provide an image or a sequence of images related to an external environment of the sensor system.

In various embodiments, the detection device includes semiconducting detection units like the chip of a charge coupled device (CCD) comprising a predefined number of pixels. The radar-camera sensor system converts the detected light into electric signals that are output by the sensor system and provides the image or sequence of images of the external environment of the radar-camera sensor system for one or more points in time.

In various embodiments, the radar-camera sensor system includes an optical sensor and at least one radar device. In various embodiments, the optical sensor and the one or more radar devices supplement each other when monitoring the external environment of the radar-camera sensor system. For example, the radar device is able to detect objects in low-light conditions (such as at night), when the intensity of light is too low for the optical sensor to monitor objects reliably. In various embodiments, the instrumental field of view of the optical sensor and the field of view of the at least one radar device are different. For example, the respective radar device may have a wide field of view with respect to an elevation and an azimuth direction which may cover approximately 150 degrees in the respective direction.

In various embodiments, the instrumental field of view of the optical sensor and the at least one radar device overlap and/or are the same. In various embodiments, the optical sensor includes an imaging device with an end facing the exterior of the sensor system and defining a front side of the sensor system. In various embodiments, the at least one radar device is located at the front side of the sensor system. Therefore, the optical sensor and the at least one radar device may face the same region of the external environment of the sensor system. Accordingly, the instrumental field of view of the optical sensor and the instrumental field of view of the at least one radar device may overlap. For example, the total instrumental field of view provided by the one or more radar devices may cover the instrumental field of view of the optical sensor entirely. Therefore, the optical sensor and the one or more radar devices may supplement each other with respect to their instrumental field of view when surveilling a certain predefined region within the external environment of the sensor system.

In various embodiments, a respective antenna element of the at least one radar device is aligned with an optical axis of the optical sensor. In other words, an instrumental field of view of the one or more radar devices and a radar lobe of the respective antenna element are centered with respect to a line that is in parallel to the optical axis of the optical sensor. The respective center line of the instrumental field of view and of the radar lobe of the respective radar device are aligned with the optical axis of the optical sensor. This ensures that the one or more radar devices cover the instrumental field of view of the optical sensor entirely in order to supplement the optical sensor.

In various embodiments, the optical sensor and the at least one antenna element extend in parallel with an optical axis of the optical sensor. In other words, one or more antenna elements may be aligned in parallel with the optical sensor. This may facilitate the installation of one or more antenna elements.

In various embodiments, the at least one antenna element may include at least one air wave guide antenna. One or more air wave guide antennas may provide a wide field of view (for example, +/−75° with respect to an elevation direction and an azimuth direction relative to the optical axis of the optical sensor). In various embodiments, the one or more air wave guide antennas provide a transmission for the radar device and face the same region of the external environment waves. In various embodiments, the open air wave guides antennas are covered (for example the open airwave guides are covered by a closure or a radome, in order to protect to the interior of the sensor system from external disturbances like moisture, dust etc.). Moreover, the radar lobe transmitted by the respective antenna element is adapted by the radome to a desired shape.

In various embodiments, the at least one antenna element includes a set of transmission elements and the instrumental field of view of a set of receiving elements. In various embodiments, the set of transmission elements and the set of receiving elements are arranged in separate spatial regions within the sensor system. For example, the respective transmission elements and the respective receiving elements of each set may be arranged as a respective group of adjacent elements with a predefined phase relationship with respect to each other. Moreover, the respective sets may be arranged close to and around the imaging device of the optical sensor such that a compact arrangement may be achieved. For example, the transmission elements and the receiving elements may end at openings at the front side of the optical sensor and the entire sensor system. For example, the radar system of the sensor system may include four transmission elements and four receiving elements, and these may be horizontally and vertically distributed. In such a configuration, phase differences may be determined between the antenna elements in order to measure an azimuth angle and an elevation angle of an object. Using four transmission elements and four receiving elements, the accuracy may be improved when determining an angle of an object (for example, with respect to the longitudinal direction of the vehicle in which the sensor system may be installed).

In various embodiments, the sensor system includes a plurality of radar devices surrounding the optical sensor. In various embodiments, the plurality of radar devices surround an imaging device of the optical sensor at a front side of the optical sensor. In various embodiments, the sensor system includes at least eight radar devices. In various embodiments, the respective radar devices of the plurality of radar devices are spaced apart at equidistant angles within a front plane of the sensor system. In various embodiments, the front plane extends at the front side of the sensor system perpendicularly to the optical axis of the optical sensor. In various embodiments, the instrumental field of view provided by the plurality of radar devices is optimized and adapted to the specific surveillance task. The plurality of radar devices allows for a specific and flexible alignment of the respective radar devices with respect to the optical sensors.

In various embodiments, the plurality of radar devices surrounding the optical sensor is arranged in a flexible manner (for example, at a front side of the sensor system) in accordance with external requirements provided for the sensor system (such as regarding the coverage of a certain region within the environment of the sensor system). In various embodiments, the radar devices are arranged in such a manner to enable multiple-input multiple output (MIMO) radar systems.

In various embodiments, the radar-camera sensor system includes a single radar device which is configured to generate and detect radar waves. A corresponding antenna element is configured to transmit and receive radar waves to and from the exterior of the sensor system. In various embodiments, the radar operation unit and its antenna element are configured to transmit or to receive radar waves only. In this case, a further external device is required for receiving or for transmitting radar waves, respectively.

In various embodiments, the radar-camera sensor system includes more than one radar device. At least one radar operation unit of the radar devices is configured to generate radar waves to be transmitted and the corresponding antenna element of the same radar device is configured to transmit the radar waves to the exterior of the sensor system. At least one other radar operation unit is configured to detect radar waves that are received by the corresponding antenna element of the same radar device. In various embodiments, the radar-camera sensor system includes at least two radar devices with at least one radar device configured as a transmitting (Tx) device and at least one other radar device configured as a receiving (Rx) device. However, the radar devices may also have a transmitting capability and a receiving capability at the same time, and a suitable arrangement of the radar devices is able to provide additional virtual channels (in addition to the Tx and Rx channels provided directly by the respective radar devices).

In various embodiments, the radar operation unit generates radar waves in a frequency range of about 76 to 81 GHz and/or above 100 GHz. In various embodiments, the radar operation unit is configured to receive radar waves with the same frequencies (in a predefined range at approximately 76 to 81 GHz or above 100 GHz). In various embodiments, the radar device is configured to monitor one or more objects in the external environment of the sensor system.

In various embodiments, the antenna element is directly attached to the radar operation unit for the at least one radar device. Therefore, the respective radar device is a compact unit and little installation space is required for the one or more radar devices. For example, the dimensions of the sensor system may be similar to a purely optical sensor even if one or more radar devices are installed in a narrow space close to the optical sensor. For example, the radar transceiver unit and the associated antenna elements may be installed in a narrow space around the optical sensor. In addition, the small spatial dimensions of the at least one radar device allow for a flexible arrangement and alignment of the one or more radar devices in the vicinity of the optical sensor. Moreover, no devices or elements are required for transferring radar waves between the antenna element and radar operation unit due to their direct attachment to each other. This reduces disturbances caused by such transfer devices or elements. In various embodiments, the radar-camera sensor system has a small footprint which allows for flexible installation of the sensor system (such as at different locations on a vehicle like a passenger car).

In various embodiments, the radar operation unit includes a radar chip (and/or radar device) and a primary printed circuit board (PCB). In various embodiments, the PCB for the radar operation unit has small dimensions (in other words, smaller dimensions than PCBs provided for the optical sensor). In various embodiments, the radar chip is configured to generate the radar waves to be transmitted by the antenna element and to detect the radar waves received by the antenna element. In various embodiments, the primary PCB includes electronic elements for controlling the operation of the radar chip and the antenna element. The antenna element and the radar chip of the at least one radar device constitute a compact unit referred to as antenna-in-package (AIP). In various embodiments, this compact unit is mounted directly at the PCB (in a similar manner as a standard chip being connected to a PCB).

In various embodiments, the optical sensor includes a detection device connected to a secondary PCB. In various embodiments, the radar operation unit of the at least one radar device is connected to the secondary PCB. In various embodiments, the connection of the radar operation unit and the secondary PCB is provided by a flexible cable, which allows for a flexible arrangement and alignment of the one or more radar devices with respect to the optical sensor. Alternatively, the connection of the radar operation unit and the secondary PCB is provided by a board-to-board connector.

Connections between the radar operation unit and the secondary PCB require little installation space. Due to this, the sensor system may still have a compact design although each of the one or more radar devices is configured as an independent unit. That is, the secondary PCB is free of any devices or elements for controlling the operation of the respective radar devices.

In various embodiments, the secondary PCB is configured to receive respective output data of the one or more radar devices for further processing. The secondary PCB is configured to provide a common data set which include a fused output of the optical sensor and of the at least one radar device. A common data set simplifies the processing of the data provided by the sensor system.

In various embodiments, the radar chip, the primary PCB and secondary PCB comprise a processing unit, at least one memory unit and at least one non-transitory data storage. The non-transitory data storage and/or the memory unit comprise a computer program for instructing the computer to perform several or all steps or aspects for processing data provided by the optical sensor and the radar transceiver unit described herein.

Alternatively, the radar transceiver unit and the feed device may be arranged at a side of the primary PCB being averted from the secondary PCB. In other words, the detection device of the optical sensor and the radar transceiver unit together with the feed device may be arranged on opposite sides of their respective PCBs. Therefore, disturbances may be decreased or avoided between the electronic elements of the optical sensor and the radar system. In addition, the radar transceiver unit and the feed device may have a good accessibility when arranged at the side being averted from the secondary PCB and the optical sensor (for example, in comparison to being arranged on an inner side facing the second PCB and the optical sensor). However, plated holes may be required in the first PCB for connecting the one or more feed devices to the one or more antenna elements.

In various embodiments, the sensor system includes a common housing which encloses the optical sensor and the at least one radar device. The common housing encloses the components of the sensor system except for openings provided for an imaging device of the optical sensor (such openings for a front lens and/or one or more openings for the respective antenna elements of the one or more radar devices). The openings allow the sensor system to interact with its external environment by transmitting radar waves into this external environment and by receiving light and radar waves from the external environment. Due to the common housing enclosing all components of the sensor system, the sensor system is a compact unit which allows for a flexible installation at different locations on a vehicle. Therefore, the sensor system is a cost-effective and flexible solution for the task of monitoring a special region close to a vehicle or within a closed room of a building.

In various embodiments, the present disclosure is directed at a vehicle comprising a sensor system as described above. In various embodiments, a number and a respective position of one or more radar devices included by the sensor system is selected in accordance with a desired position of the radar system at the vehicle. For example, when designing the vehicle, a certain spatial region is predefined which is to be monitored by the sensor system. In accordance with such a predefined spatial region, a desired instrumental field of view is defined for the sensor system, and the respective position of the radar devices with respect to the optical sensor and the number of radar devices required is determined.

### Accuracy and Reduced Distortion

The radar-camera sensor provides improved accuracy over other sensors in several ways. First, the radar and camera units share a field of view (or observation angle), which removes distortions when mapping data from one sensor onto another and enables accurate mapping of pixels to distance. Sharing an observation angle removes the need to adjust or apply correction factors to data as the distance to an object changes. For example, when a radar and camera observation angle differ, as objects move close to the sensor (or vice versa), the difference in the viewed location of the object becomes greater and greater-when the observation angle is shared, there is no difference and therefore no need for a correction factor.

Second, object detection systems frequently use cameras with “fish-eye” lenses to capture as much data as possible. However, fish-eye lenses have inherent distortion. Radar data from the same observation angle as the fish-eye lens enables simple distortion correction because the radar data provides easily mappable distance data to the distorted image data.

Third, alternative object detection systems use ultrasonic sensors to provide distance data. However, ultrasonic sensors only can detect distances and cannot provide angle data related to the distance data. In contrast, radar can provide high accuracy with distance and angle data.

The mapping of the three-dimensional distance data to the captured image data improves the BEV representation (for example, as displayed for viewing by the vehicle driver). Distortions (such as the “Manhattan effect” in which all objects appear abnormally tall) in the BEV representation can be corrected by means of reprojection of the image on a 3D map rather than on a flat plane as it is the case in traditional BEV systems.

### Example 1: Curb Height Detection

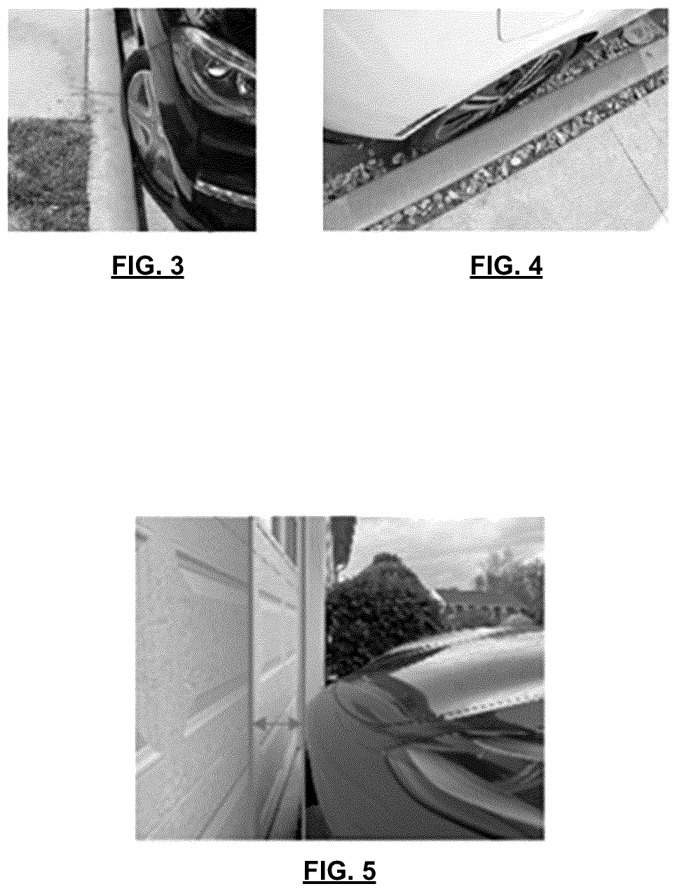

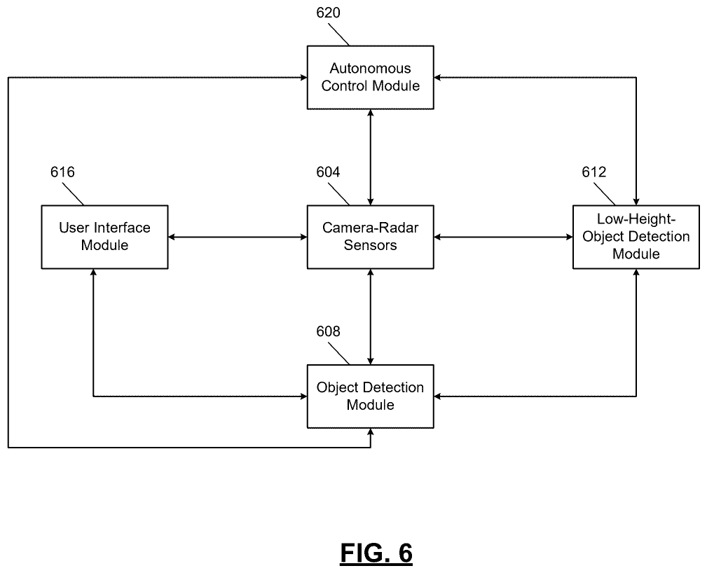

With a radar-camera sensor placed in a side-view mirror (FIG. 2) it is possible to accurately measure the height of a curbstone. This also enables a “do not scratch” feature to protect tires and rims from colliding with the curb, as the curb can be accurately detected and its height can be truly measured rather than estimated. Accurate height estimations allow for alerting vehicle occupants of the potential for vehicle door collisions with the curb (for example, via opening a vehicle door into a curb and/or other obstruction). This feature is especially helpful in scenarios (such as those depicted in FIGS. 3-4) where a vehicle is parallel and in close proximity to a curb (such as when parallel parking). In some implementations, the height of curbs (or other low-height objects) is determined in response to a determination that the object is within a threshold distance (for example 0-3 meters) of the side of a vehicle. In some implementations, an alert (such as a visual, audible, and/or haptic alert) is outputted to a driver and/or passengers in response to a car door being opened when a low-height object is present. In some implementations, the alert is outputted when the low-height object is above a threshold height (for example, a height that will impair the opening of the vehicle door). In some implementations, the alert is outputted on a displayed, haptic motor, and/or speaker associated with a specific vehicle passenger and/or driver is within the threshold distance to the low-height object. In some implementations, the sensor data is used to autonomously park a vehicle beyond a minimum distance threshold from the low-height object (for example, a distance that will not cause a collision with the low-height object when the vehicle doors are opened).

### Responsiveness

Traditional camera-based object detection requires multiple camera frames to detect movement. For example, a single camera frame alone cannot be used to detect or calculate motion; a second frame is required. However, capturing multiple frames introduces latency. This latency is eliminated using the radar-camera sensor because the radar can detect motion with a single “frame” of data. Removing the latency enables faster object detection, which is especially important for safety features like pedestrian detection.

### Example 2: Rear Object Detection

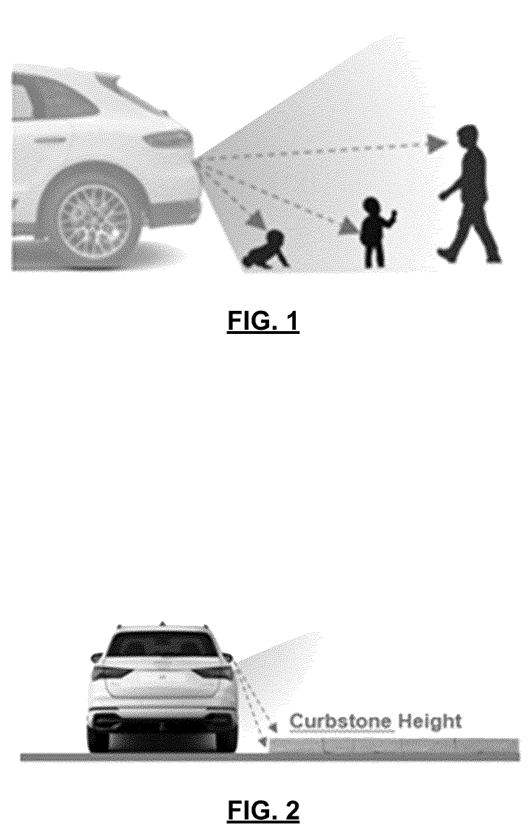

With a radar-camera sensor placed in a rear-view camera perspective (as depicted in FIG. 1), it is possible to detect obstacles and measure their exact position with respect to the vehicle, even if visibility conditions are poor and a camera system would be impaired. Radar based perception enables fast and reliable detection of vulnerable road users (such as small children, cyclists, road workers, and/or other pedestrians) when compared to ultrasonic sensors, thus enabling a robust vulnerable road user (VRU) detection for rear autonomous emergency braking (AEB) applications.

### Example 3: Distance to Obstacle Detection

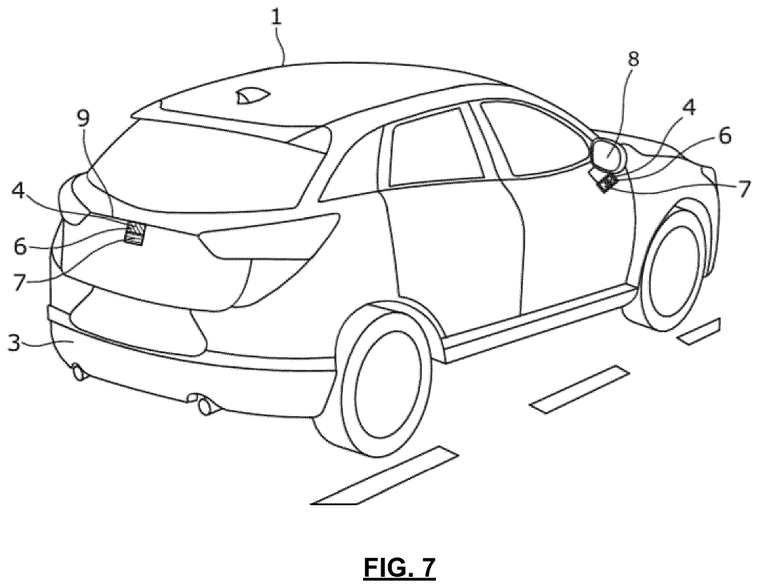

FIG. 5 is an example of obstacle detection from the front of a vehicle. With a BEV radar-camera sensor in the front of a vehicle, the BEV can be now enhanced to deliver accurate distance information to an obstacle (rather than just a picture with a distance estimate) thus enabling a more reliable autonomous parking feature or a precise virtual bumper.

The enhanced accuracy of BEV radar-camera sensors also enable autonomous parking in difficult situations such as sloped parking, diagonal parking, compact parking lot size, parallel parking on the driver's side, basement garage auto-park (without the use of GPS), pedestrians and new objects on trained parking route, and perpendicular parking next to diagonal vehicle. The enhanced 3D accuracy of the detected object facilitates pathing algorithms because the location of detected obstacles is more accurate. Additionally, available parking locations are detectable without requiring a vehicle to pass the available parking location.

### Block Diagram

FIG. 6 is an example block diagram of a system with BEV (or radar-camera) sensors. Radar-camera sensors 604 are mounted at one or more locations on a vehicle. In some implementations, radar-camera sensors 604 include radar and camera sensors in a single enclosure. In some implementations, radar-camera sensors 604 locally integrate camera data and radar data and transmit the data over a common serial bus without differentiating between the camera and radar data. In some implementations, the camera and/or radar data is processed into a third format (for example, positional data that indicates the location of objects). The sensor data (the combined radar data and camera data) from radar-camera sensors 604 is transmitted to user interface module 616, object detection module 608, low-height-object detection module 612, and autonomous control module 620.

Object detection module 608 uses sensor data from radar-camera sensors 604 to determine whether objects are within a threshold distance (for example 0-4 meters) of a vehicle. Low-height-object detection module 612 uses sensor data from radar-camera sensors 604 to determine if low-height objects (such as curbs, children, pets, etc.) are near the vehicle. In various implementations, a low-height object is characterized as being shorter than a height threshold (as an example, the height threshold is 1 meter).

In some implementations, user interface module 616 outputs alerts based on proximity to objects. For example, outputting an alert if an object suddenly appears behind or in front of the vehicle while parking. In some implementations, the alert is visual. In some implementations, the alert is haptic. In some implementations, the alert is audible. In some implementations, the audible alert changes in pitch or frequency to indicate the distance from an object. In some implementations, user interface module 616 is connected to a display device and outputs a BEV representation of the vehicle to assist drivers in parking scenarios. In some implementations, the BEV representation includes a predicted trajectory of the vehicle.

Autonomous control module 620 uses the sensor data from radar-camera sensors 604, low-height-object detection module 612, and object detection module 608 to control a vehicle in various scenarios such as automatic braking, parking, assisted lane change, assisted cruise control, and/or other driver assistance applications.

### Vehicle Diagram

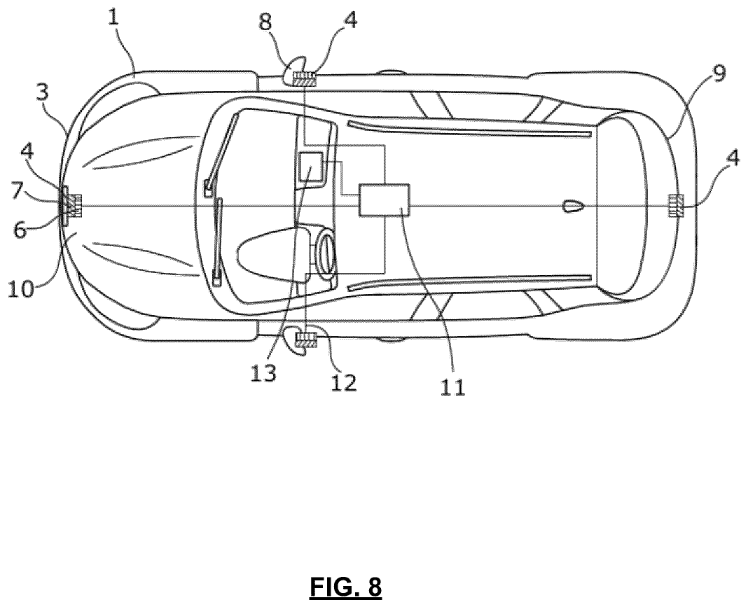

FIG. 7 shows an example rear perspective schematic view of vehicle 1 incorporating the BEV sensor system. The sensor system is used to provide a driver, or an autonomous driving system, with situational awareness of objects surrounding the periphery of the vehicle. This periphery will typically be defined by the vehicle's front bumper 3, rear bumper 3, and the vehicle's side panels between the front bumper 3 and rear bumper 3. At the same time, locations on the vehicle above the surfaces defining this perimeter, such as locations above the rear bumper 3, may be considered to be elevated locations in that they are above the vehicle's most peripheral surfaces.

In some implementations, as shown in FIG. 7, a plurality of the sensor assemblies 4 are fixed to a plurality of elevated mounting locations on the vehicle 1. In FIG. 7, four sensor assemblies 4 are used to provide fields of view covering the vehicle's front and rear ends and its sides. Specifically, in FIG. 7, a sensor assembly 4 associated with the rear of the vehicle 1 is mounted to the vehicle's tailgate 9, and two sensor assemblies 4 associated with the sides of the vehicle 1 are mounted beneath the vehicle's wing mirrors 8. As shown in FIG. 8, a sensor assembly 4 associated with the front of the vehicle 1 is mounted to the vehicle's front grill.

The BEV of the vehicle 1 shown in FIG. 8 further shows the interface connections 12 between each sensor assembly 4 and an electronic control unit (ECU) 11. In this embodiment, the ECU 11 is a central ECU for providing the vehicle's park distance control (PDC) application. In some implementations, the ECU 11 may be a central advanced driver assistance system (ADAS) domain controller. In this embodiment, the ECU 11 includes an I/O interface for receiving inputs from the camera modules 6 and radar sensors 7, and for outputting display data to a display 13 provided within the vehicle's interior. The ECU 11 further includes a microprocessor for processing the inputs and generating the display data.

In FIGS. 7-8, the camera module 6 and radar sensor 7 within each sensor assembly 4 shares a common interface connection 12 to the ECU 11. Sharing a data interface and interface cable provides cost savings and reduces installation complexity. In some implementations, separate data interfaces and interface cables may be provided for connecting the camera modules and radar sensors independently. Such independent connections may simplify connection to different ECUs within the vehicle.

During a parking operation where the vehicle is being parked, the output from each radar sensor 7 is processed by the ECU 11 to provide object detection and distance determination, thereby replicating the functionality of the conventional ultrasonic parking sensor systems. At the same time, the camera modules 6 provide a video feed for visualisation of the surrounding area. Accordingly, the downfacing configuration of the camera modules 6 and radar sensors 7 within each sensor assembly 4, together with their elevated mounting locations, provide camera and radar fields of view around the periphery of the vehicle 1. The output feeds from the camera module and radar sensors are processed by the ECU 11 and output to a Human Machine Interface (HMI). In some implementations, the Human Machine Interface (HMI) is implemented using the video display 13 within the vehicle for displaying a composite 360° above-vehicle view of the surroundings, augmented by a distance indicator for showing distance between objects and the periphery of the vehicle 1. In this way, the driver is provided with a representation of distances between detected objects and the periphery of the vehicle, in addition to being able to visualise the surroundings.

The downfacing mounting allows the radar sensor 7 to be installed in the same elevated locations as the camera modules 6. In other words, both camera and radar components may be installed in the same mounting compartments on the vehicle. Accordingly, rather than the sixteen mountings required by typical conventional camera/ultrasonic parking systems, a complete 360° field of view may be provided using only four mounting locations, namely, the front, rear and side locations. The two sensor technologies may therefore be combined in the same position on the vehicle for simplifying installation and minimising costs, while still facilitating obstacle detection, distance measurement, and providing visualization of the surrounding area during vehicle parking.

In some implementations, not all the sensor assemblies require a camera module. For instance, a camera module may be incorporated into the rear sensor assembly, or the front and rear sensor assembly, with the remaining sensor assemblies including the radar sensors only. Such configurations may thereby provide obstacle detection and distance measurement using the radar sensors in their downfacing orientation, with the camera modules aiding the driver's awareness by providing a rear, or front and rear, video feed.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order. Numerical terms, such as “first,” “second,” and “third,” may be used in the disclosure and claims as unique labels: they are not used to imply a sequence or order unless the context clear indicates otherwise. In other words, a “second element” could be relabeled as a “first element” without departing from the principles of the present disclosure. Further, the presence of a “second element” does not imply or require the presence of a “first element.”

Unless the context clearly indicates otherwise, the singular articles “a,” “an,” and “the” before a noun do not restrict the noun to a single instance. The verbs “comprise,” “include,” and “have” are inclusive and therefore specify the presence of elements without excluding the presence of one or more additional elements.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “coupled,” “engaged,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present (either spatially or functionally) between the first and second elements.

The term “set” generally means a grouping of one or more elements. The elements of a set do not necessarily need to have any characteristics in common or otherwise belong together. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR. The phrase “A, B, and/or C” should be construed in the same way as the phrase “at least one of A, B, and C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgments of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

1. A vehicle control system comprising:
a sensor device including:
an optical sensor with a first field of view,
a radar with a second field of view, and
a common housing enclosing the optical sensor and the radar,
wherein the radar includes a transceiver and an antenna element, and
wherein the sensor device is configured to be installed at an exterior surface of a vehicle; and
a control module configured to:
receive sensor data, including both optical data and radar data, from the sensor device over a shared communications channel,
determine, based on a single frame of the optical data and a corresponding portion of the radar data, whether an object is present within a threshold distance of the vehicle, and
in response to a determination of presence of the object:
determine, based on the single frame and the corresponding portion of the radar data, whether the object is moving,
in response to a determination that the object is moving, determine, using the sensor data, whether the object satisfies one or more of a set of alert criteria, and
in response to a determination that the object satisfies one or more of the set of alert criteria, generate an alert and a set of characteristic data describing the object.

2. The vehicle control system of claim 1 wherein the control module is configured to:
using the radar data, map pixels of the optical data to distances;
determine, based on the sensor data, whether a low-height object is present within a threshold distance of the vehicle, wherein the low-height object is characterized by having a height less than a height threshold; and
in response to a determination of presence of the low-height object:
determine whether the low-height object satisfies one or more of a set of low-height alert criteria, and
in response to a determination that the low-height object satisfies one or more of the set of low-height alert criteria, generate the alert and a set of characteristic data describing the low-height object.

3. The vehicle control system of claim 1 wherein the first field of view and the second field of view overlap.

4. The vehicle control system of claim 3 wherein the first field of view and the second field of view are coextensive.

5. The vehicle control system of claim 1 wherein the second field of view is aligned with an optical axis of the optical sensor.

6. The vehicle control system of claim 5 wherein a radar lobe of the antenna element is centered with respect to a line that is in parallel to the optical axis.

7. The vehicle control system of claim 1 wherein the transceiver is directly connected to the antenna element.

8. The vehicle control system of claim 1 wherein the radar includes a plurality of antenna elements, of which the antenna element is one.

9. The vehicle control system of claim 1 wherein the control module is configured to generate an output to a driver of the vehicle in response to the alert.

10. The vehicle control system of claim 9 wherein the output includes at least one of:
a visual alert on a user interface associated with a driver of the vehicle;
an auditory alert; and
a haptic alert.

11. The vehicle control system of claim 1 wherein the control module is configured to control the vehicle in response to the alert.

12. The vehicle control system of claim 11 wherein the control module is configured to selectively reduce speed of the vehicle in response to the alert.

13. The vehicle control system of claim 12 wherein the control module is configured to selectively reduce the speed of the vehicle to zero in response to the alert.

14. The vehicle control system of claim 11 wherein the control module is configured to selectively modify a steering angle of the vehicle in response to the alert.

15. The vehicle control system of claim 11 wherein the control module is configured to:
determine, from the set of characteristic data, whether the object is located in a direction of travel of the vehicle; and
control the vehicle in response to a determination that the object is located in the direction of travel.

16. The vehicle control system of claim 11 wherein the control module is configured to:
predict, from the set of characteristic data, whether, at a future point in time, a first envelope defining the exterior surface of the vehicle overlaps with a second envelope defining an exterior of the object; and
control the vehicle in response to a prediction that the first envelope and the second envelope will overlap.

17. The vehicle control system of claim 16 wherein:
the first envelope is a polyhedron; and
the second envelope is a polyhedron.

18. The vehicle control system of claim 1 wherein the threshold distance is in a range of 1 meter to 3 meters.

19. The vehicle control system of claim 1 wherein the control module is configured to project the sensor data on a representation of a three-dimensional map in a user interface.

20. The vehicle control system of claim 1 wherein:
the set of alert criteria includes a criterion that is met when the object is within a second threshold distance of the vehicle; and
the second threshold distance is less than the threshold distance.
